(19) United States
(12) Patent Application Publication
(10) Pub. No.: US 2020/0027097 A1
(43) Pub. Date: Jan. 23, 2020

(54) Systems and Methods for Management of Relationships with Third Party Vendors

(71) Applicant: Baker, Donelson, Bearman, Caldwell & Berkowitz, PC, Nashville, TN (US)

(72) Inventor: Scott Sargent, Birmingham, AL (US)

(21) Appl. No.: 16/517,595

(22) Filed: Jul. 20, 2019

Related U.S. Application Data
(60) Provisional application No. 62/701,010, filed on Jul. 20, 2018.

(51) Int. Cl. G06Q 30/00

(52) U.S. Cl. CPC G06Q 30/018

(57) ABSTRACT

Disclosed herein are systems and methods for managing third-party vendor relationships. Embodiments provide a single source to address and manage third-party vendor relationships from beginning to end. Various exemplary embodiments include a pre-engagement phase, a risk assessment phase, a due diligence phase, a contracting phase, and a monitoring and reporting phase. The subject matter disclosed herein can assist entities with compliance of their regulatory obligations.

### CROSS REFERENCE TO RELATED APPLICATIONS

This application claims the benefit of U.S. Provisional Application No. 62/701,010 entitled “Systems and Methods for Management of Relationships with Third Party Vendors” and filed on 20 Jul. 2018, the contents of which are incorporated by reference in its entirety.

### FIELD OF THE INVENTION

The invention relates generally to third-party vendor management. More specifically, the invention relates to a method for addressing and managing relationships between stringently regulated institutions and third-party vendors.

### BACKGROUND

Across the United States, financial institutions of every type and size depend upon external vendors to provide many, if not most, of their operational needs. These needs include daily payment and deposit processing, online banking, online account origination, marketing, cash delivery, statement processing, ATM servicing, telephone services, accounting, and other operational requirements. As this industry increased its dependence upon external vendors, federal regulators that provide oversight and examination for financial institutions have heightened their focus on the risks posed by the use of third-party service providers. To mitigate this risk, regulators imposed a series of strict guidelines for institutions that utilize third-party services, including 2008 guidelines promulgated by the Federal Deposit Insurance Corporation (“FDIC”), 2012 mandates from the Consumer Financial Protection Bureau (“CFPB”), and 2013 guidance from the Office of Consumer Compliance (“OCC”) and the Federal Reserve (the “Fed”). The CFPB updated its guidance in 2016, and the OCC followed in 2017.

State governments and agencies joined federal regulators in their oversight of financial institutions located within their borders. Many state legislatures have the authority to examine bank service providers and have intensified their efforts following perceived public failures of federal regulators to ensure safe, secure, and reliable practices by third-party service providers.

On Feb. 19, 2018, the American Bankers Association published a list of the top bank risks for 2018. Third-party vendor risk was listed at number two. The article stated that regulators routinely mention “weakness in the ability of community banks' staff to analyze and put appropriate controls in place.” Put simply, regulators expect and require that banks know which entities provide third-party services to them. Yet, third-party risk oversight requires more than keeping an inventory of vendors. Thus, regulators require banks to allocate resources and personnel with adequate experience and expertise to oversee and manage their third-party service providers.

Banks in the United States spent an estimated $260 billion on compliance-related operating expense in 2016, and these costs consumed over 10 percent of the operating budget for many institutions. Due to the increased frequency of consumer information data breaches, it is expected that vendor management oversight will remain a priority for regulatory agencies and legislative bodies. As a result, it is likely that vendor compliance costs will only continue to rise.

### SUMMARY

Embodiments of the present invention provide, among other things, a single source to address and manage third-party vendor relationships from beginning to end. It includes procedures for establishing servicing requirements and strategies, selecting third-party vendors, negotiating contracts, and monitoring, changing, or discontinuing an outsourced relationship. Various embodiments of the present invention assist banks and other financial institutions with compliance of their regulatory obligations.

In one aspect, a method of managing one or more third-party vendor relationships from a single source is disclosed herein. In embodiments, the method comprises the steps of conducting a pre-engagement meeting with a client; conducting a risk assessment phase, wherein a vendor management entity determines and reviews the client's applicable regulatory categories and the vendor management entity further analyzes the client's risks associated with current or proposed vendor relationships; conducting a due diligence phase, wherein the vendor management entity performs a due diligence review of a third-party vendor; and conducting a monitoring and reporting phase, wherein the vendor management entity provides monitoring and reporting of the third-party vendor's compliance with applicable regulatory requirements.

In certain embodiments, the pre-engagement meeting comprises any one or more of the following: determining the needs of the client, developing a plan to transition vendor management from the client's internal resources to the vendor management system, determining any third-party vendors currently engaged by the client, and reviewing a list of potential third-party vendors to be engaged by the client.

In one embodiment, the method includes conducting a contracting phase, wherein the vendor management entity negotiates and drafts required contractual agreements between the client and the third-party vendor.

The due diligence phase can comprise a financial review, a security review, a review of operations, a compliance/legal review, or a combination thereof.

In certain embodiments, the method comprises reviewing the third-party vendor's policies, processes, internal controls, or a combination thereof.

The monitoring and reporting phase can comprises determining whether the third-party vendor relationship involves a critical activity, wherein, if the third-party vendor relationship involves a critical activity, the vendor management entity provides status reports at more frequent intervals as compared to third-party vendor relationships that involve a non-critical activity, performs more comprehensive monitoring and reporting as compared to third-party vendor relationships that involve a non-critical activity, or a combination thereof. In one embodiment, the monitoring and reporting phase comprises monitoring for any issue, deficiency, concern, or red flag, and notifying the client if any issue, deficiency, concern, or red flag is discovered. In embodiments, notifying the client comprises issuing a deficiency report to the client, wherein the deficiency report comprises an identification of the particular cause for concern, an explanation of what triggered the red flag, or a combination thereof. In an embodiment, if a deficiency report is issued to the client regarding a particular third-party vendor, the vendor management entity increases the frequency of status reports for the particular third-party vendor, performs more comprehensive monitoring and reporting for the particular third-party vendor, or a combination thereof. The monitoring and reporting phase can be ongoing or can comprise a one-time delivery of a report.

Another aspect includes a centralized system for managing third-party vendor relationships. In various exemplary embodiments, the centralized system comprises a vendor management entity, a client, and a third-party vendor, wherein the vendor management entity provides a vendor management service. The vendor management service can comprises one or more of the following: a pre-engagement phase, a risk assessment phase, a due diligence phase, a contracting phase, and a monitoring and reporting phase. In one embodiment, the system comprises a life cycle of services that move serially through the pre-engagement phase, the risk assessment phase, the due diligence phase, the contracting phase, and the monitoring and reporting phase.

The due diligence review can comprise an operational review, wherein the operational review comprises an analysis of the third-party vendor's strategies, goals, employment policies, employment practices, growth plans, business experience, reputation, market share, reference checks, qualifications, resilience, incident reporting, management programs, human resources management, talent retention, or a combination thereof.

The system can include a subcontractor review phase, wherein the subcontractor review phase comprise an evaluation of the volume and types of the third-party vendor's subcontracted activities, and an evaluation of the third-party vendor's ability to assess, monitor, and mitigate risks associated with the third-party vendor's use of subcontractors. In embodiments, the subcontractor review phase further comprises an evaluation of potential legal and financial implications of the third-party vendor's legally binding arrangements with subcontractors.

In various embodiments, the vendor management service is provided to the client remotely. The vendor management service can comprise regulatory exam assistance. In various embodiments, the client comprises an entity within an industry, filed, or business that is subject to stringent regulation.

Advantages of the several embodiments disclosed herein include an innovative and sustainable model that will significantly reduce the regulatory burden of financial institutions or other stringently regulated businesses while providing reliable fees at high profit margins, with significant potential for exponential returns. With lightened regulatory burdens, participating institutions are free to use their resources in a more productive and efficient manner.

Other aspects and advantages of the invention will be apparent from the following description and the appended claims.

### BRIEF DESCRIPTION OF DRAWINGS

FIG. 1 provides an overview of services provided under the presently disclosed vendor management systems and methods, under one embodiment.

FIG. 2 shows a flow chart diagram of an exemplary monitoring and reporting phase, under one embodiment.

### DETAILED DESCRIPTION

Detailed descriptions of one or more embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate manner.

The singular forms “a,” “an,” and “the” include plural reference unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

The term “vendor management entity” includes, without any limitation, the person, business, organization, institution, or other entity providing the vendor management methods and services as disclosed herein.

The term “client” includes, without limitation, the person, business, organization, institution, or other entity receiving or otherwise participating in the vendor management methods and services as disclosed herein.

The term “vendor,” “third-party vendor,” and “third party” are used interchangeably herein, and can refer to party offering services or products to a client. In embodiments, vendors can provide certain operational needs to the client.

These increasing regulatory burdens and associated expenses highlight the need for efficient methods of vendor management services. Effective vendor management systems and methods are required that assist with risk assessment, perform due diligence, provide contract review services, and provide ongoing monitoring for vendors and third-party services providers for banks. In addition, there exists a need for vendor management systems and methods that provide periodic reports to the financial institutions based on their needs, wherein the frequency of the reports depend upon associated risk.

In various exemplary embodiments, the present invention comprises a system and related methods for providing third-party vendor management. In non-limiting embodiments, vendor management is provided for financial institutions including investment banks, commercial banks, credit unions, savings and loans, brokerages, insurance companies, management investment companies, or a combination thereof. The vendor management system can be provided to commercial banks.

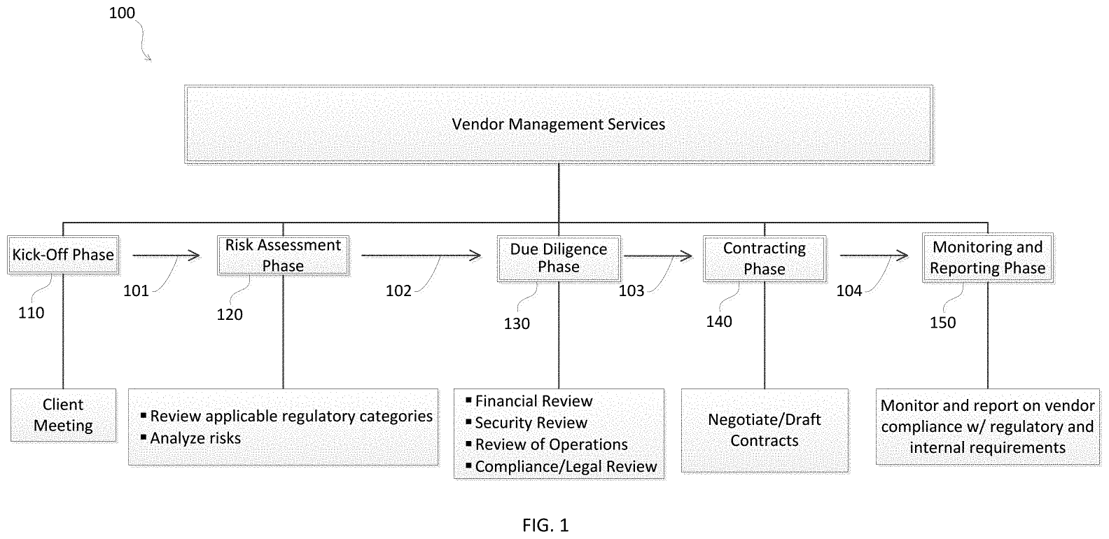

In one exemplary embodiment, as shown in FIG. 1, the presently disclosed systems and methods 100 comprise one or more of the following services: a pre-engagement meeting or “Kick Off” phase 110, a risk assessment phase 120, a due diligence phase 130, a contracting phase 140, and a monitoring and reporting phase 150. The vender management system 100 can be offered a la carte, whereby a client selects one or more services the client wishes to receive. Alternate embodiments offer a complete Life Cycle of Services. In embodiments comprising a complete Life Cycle of Services, the vendor management system and methods 100 begin from the kick-off phase 110 and move serially through the offered services (see arrows 101-104) until the third-party vendor relationship is terminated or the client ceases use of the vendor management system. The pre-engagement meeting or “Kick Off” phase 110 can comprise a meeting with a client to establish a timeline for the onboarding process. In certain embodiments, the onboarding process involves any one or more of the following: determining the needs of the client, developing a plan to transition vendor management from client's internal resources to the vendor management system, and identifying/implementing resources within the vendor management system that are most pertinent to the particular client's needs. The Kick-off phase can further include determining any third-party vendors currently engaged by the client or reviewing of a list of potential third-party vendors to be engaged by the client. The pre-engagement phase 110 can further include an evaluation of internal resources available to the vender management entity and how to best service the client. By way of example, such an evaluation can include, but is not limited to, any one or more of the following: whether specific programming needs to be performed to meet the needs of the particular client, evaluating an appropriate plan for periodic reporting, determining the optimal frequency for following up with the client's vendors, determining the information that needs to be obtained from each vendor, determining client personnel to be responsible for receiving/reviewing vendor reports, evaluating the need for regulatory consultation, and the like. Similarly, the Kick-Off phase can comprise an evaluation of other resources at the disposal of the client. This process can include evaluating the client's current vendor management software or services from existing vendors to avoid redundancies in the vendor management system and reduce client expenses. In embodiments, the pre-engagement phase 110 includes the transfer of one or more files, wherein the vender management entity receives reports or other information about the client's vendors or vendor selection process. By way of non-limiting example, file transfers comprise receipt of one or more of the following: the client's existing due diligence, contracts between the client and any third-party vendors, monitoring data, and any other documentation relating to the client's relationship with third-party vendors. The vender management system can also include an evaluation of the client's pre-existing vendor management policies or procedures.

The risk assessment phase 120 can comprises an analysis of risk assessment data for one or more of the client's existing or proposed outsourced relationships with third-party vendors. During this phase, the vender management system 100 includes a review of regulatory categories of risk to ensure the client has addressed all applicable requirements.

In embodiments, the due diligence phase 130, comprises a review the client's prior due diligence or initial due diligence for each vendor. Due diligence review 130 can include one or more of the following: a financial review, a security review, a review of operations, a compliance/legal review, or a combination thereof. The financial review can include a review of the client's financial condition, financial statements, obligations, revenue sources, fees, to insurance, or a combination thereof. In certain embodiments, external accountants can be engaged to assist with the financial review.

The security review can comprise a review of the third-party vendor's information security, physical security, safeguards, controls, training, or a combination thereof. External security firms can be engaged to assist with the security review.

The operational review can comprise an analysis of the third-party vendor's strategies, goals, employment policies, employment practices, growth plans, business experience, reputation, market share, reference checks, qualifications, resilience (business continuity and disaster recovery), incident reporting, management programs, human resources management, talent retention, or a combination thereof. In embodiments, during operational diligence review, the vendor management entity obtains a clear understanding of the third-party vendor's business processes and the technology used to provide services to the client. In situations where technology is a major component of the third-party relationship, the vendor management entity can review the client's information systems, the third-party vendor's information systems, or both systems to identify gaps or short comings. In embodiments, the exemplary aspects of information systems are evaluated for gaps or shortcomings: service-level expectations, technology, business process and management, interoperability issues, or a combination thereof. In embodiments, the operations diligence review comprises a review the third party's processes for maintaining accurate inventories of the third-party's technology and its subcontractors. Operational review can comprise an assessment of the third party's change management processes to ensure that clear roles, responsibilities, and proper segregation of duties are in place. The vendor management entity can evaluate the third party's performance metrics for its information systems and can ensure that the performance metrics meet the bank's expectations.

The compliance/legal review can comprise an evaluation of the third-party vendor's existing legal and regulatory compliance programs. Such a review can comprise a determination of whether the third party has the necessary licenses to operate. In certain embodiments, the compliance/legal review comprises assessing the third party's expertise, processes, and controls to ensure that the client remains compliant with domestic and international laws and regulations. The vendor management entity can further provide ongoing review of third-party vendor compliance status with regulators and self-regulatory organizations, as appropriate (see the monitoring and reporting phase 150, discussed in more detail below).

Various exemplary embodiments comprise additional risk management functions. One embodiment provides for evaluating the effectiveness of the third party's risk management program. This risk management evaluation can include a review of the third-party vendor's policies, processes, internal controls, or a combination thereof. Where applicable, the systems and methods described herein evaluate whether the third party's internal audit function independently and effectively tests and reports on the third party's internal controls.

Embodiments are further configured to analyze third party processes for escalating, remediating, or holding management accountable for concerns identified during audits or other independent tests. Certain embodiments provide for review of Service Organization Control (SOC) reports, prepared in accordance with the American Institute of Certified Public Accountants' Statement on Standards for Attestation Engagements No. 16 (SSAE 16), to determine whether these reports contain sufficient information to assess the third party's risk or whether additional scrutiny is required through an audit by the client or other party at the client's request. The system and methods disclosed herein can further include a review of certifications for compliance with domestic or international internal control standards (e.g., the National Institute of Standards and Technology and the International Organization for Standardization). In one embodiment, certification compliance review is performed via independent third parties.

Embodiments of the vender management system and methods are equipped to review the vendor's incident reporting and management programs to ensure there are clearly documented processes and accountability for identifying, reporting, investigating, and escalating data security concerns or other incidents. These reviews ensure that the third party's escalation and notification processes meet the client's expectations and regulatory requirements.

Certain embodiments evaluate the volume and types of subcontracted activities and the subcontractors' geographic locations. The vender management methods can also evaluate the third party's ability to assess, monitor, and mitigate risks from its use of subcontractors. In embodiments, such an evaluation can ensure that the same level of quality and controls exists regardless of where the subcontractors' operations reside. Additionally, embodiments can provide for determining whether additional concentration-related risks may arise from the third-party vendor's reliance on subcontractors and, if necessary, conduct similar due diligence on the third party's critical subcontractors.

An important feature of certain embodiments includes obtaining information regarding legally binding arrangements with subcontractors or other parties in cases where the third party has indemnified itself, as such arrangements may transfer risks to the client. Such vendor management methods evaluate the potential legal and financial implications of these contracts between the third party and its subcontractors or other parties.

In the contracting phase 140, the vendor manager systems and methods can engage or coordinate with law firms to negotiate and draft a contract that clearly specifies the rights and responsibilities of each party. Under alternate embodiments, the vendor management system employs in-house legal counsel for contract review and negotiation. Following regulatory guidance, the contract will generally address one or more of the following: the nature and scope of the arrangement; performance measures or benchmarks; responsibilities for providing, receiving, and retaining information; the right to audit and require remediation; the responsibility for compliance with applicable laws and regulations; cost or compensation; ownership and licensing; confidentiality and integrity; business resumption and contingency plans; indemnification; insurance; dispute resolution; limits on liability; default and termination; customer complaints; subcontracting; foreign-based third parties; regulatory supervision; or a combination thereof.

In embodiments, the monitoring and reporting phase 150 provides for ongoing monitoring for the duration of the third-party relationship. Under certain regulatory requirements this is a highly important component of the client's risk management process. Heightened and more comprehensive monitoring is often necessary when the third-party vendor relationship involves critical activities. Thus, an important step of this process includes a determination of whether the nature of the activity performed through third-party relationships constitutes a critical activity. In embodiments, this determination is made by or with the assistance of the client's senior management. Regular on-site visits can be employed to understand fully the third party's operations and ongoing ability to meet contract requirements.

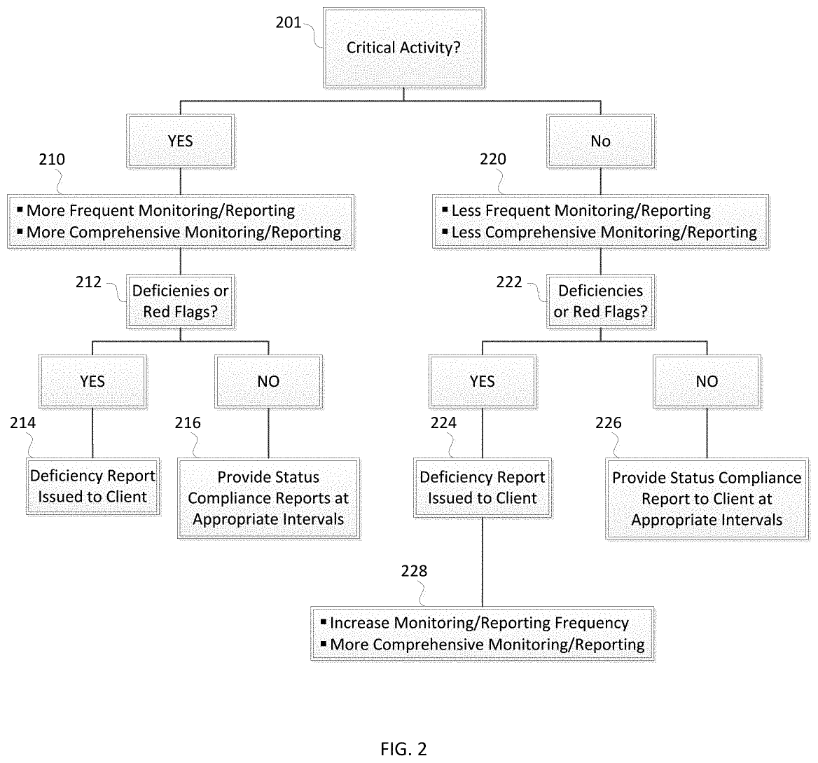

The embodiment shown in FIG. 2 provides an example of ongoing monitoring and reporting activities provided through the vendor management systems and methods as disclosed herein. As briefly discussed above and shown in the FIG. 2 embodiment, an important preliminary assessment is to determine whether third-party vendor provides a critical activity 201 for the client. Whether a particular service represents a critical activity 201 can depend on the client or the client's business model, and can vary from one client to the next. Thus, what is categorized as a critical activity 201 for a first client may not represent a critical activity 201 for a second client, and vice versa.

As shown in FIG. 2, if a third-party vendor relationship governs a critical activity 201 for the client, the vendor management entity can perform more frequent and comprehensive monitoring and reporting to the client 210. In certain embodiments, more frequent monitoring and reporting comprises daily, weekly, or monthly monitoring or reporting. Upon the discovery of any deficiencies, non-compliance, red flags, or other issues, a deficiency report 214 can be sent to the client. The deficiency report can comprise an identification of the particular cause for concern, an explanation of what triggered the red flag, or a combination thereof. In an exemplary, non-limiting embodiment, the deficiency report includes a detailed report of any non-compliance with applicable regulations, suggested actions for the client to remedy the concern, a recommendation of termination of the relationship, or a combination thereof In the alternative, if no deficiencies or red flags are discovered, the vendor management entity provides status reports at regularly scheduled intervals as deemed appropriate by the client, vendor management entity, regulatory body, or a combination thereof 216.

As further detailed in the FIG. 2 embodiment, less frequent or less comprehensive monitoring and reporting 220 can be appropriate for evaluating vendor services for non-critical activities. In certain embodiments, less frequent monitoring comprises quarterly, semiannual, or annual monitoring or reporting. Upon discovery of a deficiency or red flag 222 a deficiency report 224, as discussed in detail above, can be issued to the client. Upon issuance of a deficiency report 224, the vendor management entity may recommend frequent or more comprehensive monitoring and reporting 228 for a given time or until the client or vendor management entity, or both, are satisfied that the vendor is and will remain in compliance with the applicable rule or regulation. When no deficiencies are discovered, status reports can be issued at regular and appropriate intervals 226.

In embodiments, the third-party vendor's activities and performance is monitored with particular attention to the quality and sustainability of the third party's controls and its ability to meet service-level agreements, performance metrics, or other contractual terms. The third-party vendor's ability to comply with legal and regulatory requirements can be a particularly important parameter to be monitored during the monitoring and reporting phase 150.

Because both the level and types of risks may change over the lifetime of third-party relationships, certain systems and methods disclosed herein ensure that ongoing monitoring can adapt accordingly. This monitoring may result in changes to the frequency and types of required reports from the third party (see FIG. 2), including service-level agreement performance reports, audit reports, and control testing results. For instance, as discussed above with regard to FIG. 2, certain deficiencies or red flags associated with a particular vendor may warrant increased monitoring and reporting frequency or a more comprehensive monitoring program, even if the vendor provides an otherwise non-critical activity.

In addition to ongoing review of third-party reports, some key areas of consideration for ongoing monitoring can include assessing any changes to the third party's business strategy (including acquisitions, divestitures, joint ventures) and reputational risks (including litigation) that may pose conflicting interests or otherwise impact the vendor's ability to meet contractual obligations or service-level agreements. Further important vendor parameters that can be monitored include one or more of the following: compliance with legal and regulatory requirements; financial condition of the vendor; insurance coverage; key personnel and ability to retain essential knowledge in support of the activities; ability to effectively manage risk by identifying and addressing issues before they are cited in audit reports; process for adjusting policies, procedures, and controls in response to changing threats, new vulnerabilities, and material data security breaches or other serious data security incidents; information technology used or the management of information systems; ability to respond to and recover from service disruptions or degradations and meet business resilience expectations; reliance on, exposure to, or performance of subcontractors; location of subcontractors; the ongoing monitoring and control testing of subcontractors; agreements with other entities that may pose a conflict of interest or introduce reputation, operational, or other risks to the client; ability to maintain the confidentiality and integrity of the client's information and systems; volume, nature, and trends of consumer complaints, in particular those that indicate compliance or risk management problems; and the vendor's ability to appropriately remediate customer complaints.

As a part of the reporting phase, the vendor management systems and methods disclosed herein include notifying the client of any issues, deficiencies, concerns, or other red flags uncovered through ongoing monitoring 214, 224. In embodiments, these issues, deficiencies, concerns, or other red flags include increases in risk, material weaknesses, repeat audit findings, deterioration in financial condition, data security breaches, data loss, service or system interruptions, compliance lapses, other deficiencies or concerns, or a combination thereof.

Embodiments can be configured to render one or more services to clients remotely. Under an exemplary embodiment, reports for vendors are provided via secure portals or delivery services, according to their internal requirements and the mandates of engagement. By way of non-limiting example, due diligence on a particular vendor can be a one-time delivery within an agreed timeframe, while ongoing monitoring can require reports daily, weekly, monthly, quarterly, or annually, depending on the relationship.

The vendor management systems and methods disclosed herein permit financial institutions of every size to manage all of their outsourced vendor management obligations within a single point of contact.

Embodiments of the presently disclosed vendor management systems and methods provide for assistance with risk analysis; due diligence analysis of third-party vendors; reporting due diligence results to the client; drafting and negotiating compliant contracts; ensuring that third parties comply with the client's policies and reporting requirements; ongoing monitoring of third parties and ensuring compliance with contract terms and service-level agreements; regularly reporting results of ongoing monitoring to clients; ensuring that third parties conduct regular testing and implement agreed-upon remedial steps when issues arise; maintaining appropriate documentation throughout the life cycle of services; or combinations thereof. In embodiments appropriate documentation comprises (a) current inventories of all third-party relationships, which can include identifying those relationships that involve critical activities and delineating the risks posed by those relationships across the client; b) due diligence results, findings, and recommendations; c) executed contracts; d) regular risk management and performance reports required and received from the third party (e.g., audit reports, security reviews, and reports indicating compliance with service-level agreements); (e) regular reports to the board and senior management on the results of internal control testing and ongoing monitoring of third parties involved in critical activities; f) regular reports to the board and senior management on the results of independent reviews of the clients' overall risk management process; or a combination thereof.

Embodiments can further include offering, providing, or selling regulatory exam assistance to clients.

Examples of the present invention have been presented for use with vendor relationships between financial institutions. However, it should be understood that the methods described could also be applied to other industries, fields, or businesses that are subject to enhanced regulatory environments. Such fields include but are not limited to real estate, healthcare, medicine, the pharmaceutical industry, food processing and manufacturing, petroleum and coal products manufacturing, power generation and transmission/distribution, air transportation, motor vehicle manufacturing, and other industries burdened by regulatory demands.

While the invention has been described with respect to a single embodiment, those skilled in the art, having benefit of this disclosure, will appreciate that other embodiments can be devised which do not depart from the scope of the invention as disclosed here.

What is claimed is:

1. A method of managing third-party vendor relationships from a single source comprising the steps of:
conducting a pre-engagement meeting with a client;
conducting a risk assessment phase, wherein a vendor management entity determines and reviews the client's applicable regulatory categories and the vendor management entity further analyzes the client's risks associated with current or proposed vendor relationships;
conducting a due diligence phase, wherein the vendor management entity performs a due diligence review of a third-party vendor; and
conducting a monitoring and reporting phase, wherein the vendor management entity provides monitoring and reporting of the third-party vendor's compliance with applicable regulatory requirements.

2. The method of claim 1, wherein the pre-engagement meeting comprises any one or more of the following:
determining the needs of the client, developing a plan to transition vendor management from the client's internal resources to the vendor management system, determining any third-party vendors currently engaged by the client, and reviewing a list of potential third-party vendors to be engaged by the client.

3. The method of claim 1, further comprising the step of:
conducting a contracting phase, wherein the vendor management entity negotiates and drafts required contractual agreements between the client and the third-party vendor.

4. The method of claim 1, wherein the due diligence phase comprises a financial review, a security review, a review of operations, a compliance/legal review, or a combination thereof.

5. The method of claim 1, further comprising the step of:
reviewing the third-party vendor's policies, processes, internal controls, or a combination thereof.

6. The method of claim 1, wherein the monitoring and reporting phase comprises:
determining whether the third-party vendor relationship involves a critical activity, wherein
if the third-party vendor relationship involves a critical activity, the vendor management entity provides status reports at more frequent intervals as compared to third-party vendor relationships that involve a non-critical activity, performs more comprehensive monitoring and reporting as compared to third-party vendor relationships that involve a non-critical activity, or a combination thereof.

7. The method of claim 1, wherein the monitoring and reporting phase comprises:
monitoring for any issue, deficiency, concern, or red flag, and notifying the client if any issue, deficiency, concern, or red flag is discovered, wherein
notifying the client comprises issuing a deficiency report to the client, wherein the deficiency report comprises an identification of the particular cause for concern, an explanation of what triggered the red flag, or a combination thereof

8. The method of claim 7, wherein if a deficiency report is issued to the client regarding a particular third-party vendor, the vendor management entity increases the frequency of status reports for the particular third-party vendor, performs more comprehensive monitoring and reporting for the particular third-party vendor, or a combination thereof.

9. The method of claim 1, wherein the monitoring and reporting phase is ongoing.

10. The method of claim 1, wherein the monitoring and reporting phase comprises a one-time delivery of a report.

11. A centralized system for managing third-party vendor relationships comprising:
a vendor management entity;
a client;
a third-party vendor; wherein the vendor management entity provides a vendor management service; and
the vendor management service comprises one or more of the following:
a pre-engagement phase, a risk assessment phase, a due diligence phase, a contracting phase, and a monitoring and reporting phase.

12. The system of claim 11, wherein the system comprises a life cycle of services that move serially through the pre-engagement phase, the risk assessment phase, the due diligence phase, the contracting phase, and the monitoring and reporting phase.

13. The system of claim 11, wherein the due diligence review comprises an operational review, wherein the operational review comprises an analysis of the third-party vendor's strategies, goals, employment policies, employment practices, growth plans, business experience, reputation, market share, reference checks, qualifications, resilience, incident reporting, management programs, human resources management, talent retention, or a combination thereof.

14. The system of claim 11, further comprising a subcontractor review phase, wherein the subcontractor review phase comprise an evaluation of the volume and types of the third-party vendor's subcontracted activities, and an evaluation of the third-party vendor's ability to assess, monitor, and mitigate risks associated with the third-party vendor's use of subcontractors.

15. The system of claim 11, wherein the subcontractor review phase further comprises an evaluation of potential legal and financial implications of the third-party vendor's legally binding arrangements with subcontractors.

16. The system of claim 11, wherein the vendor management service is provided to the client remotely.

17. The system of claim 11, vendor management service comprises regulatory exam assistance.

18. The system of claim 11, wherein the client comprises an entity within an industry, filed, or business that is subject to stringent regulation.
